(19) United States
(12) Patent Application Publication
(10) Pub. No.: US 2022/0153261 A1
(43) Pub. Date: May 19, 2022

(54) Vehicle To Device Proximity Detection Using Location Comparison

(71) Applicant: Ford Global Technologies, LLC, Dearborn, MI (US)

(72) Inventors: Hussam Makkiya, Dearborn, MI (US); Colin Drummond, Windsor (CA); Venkat Aekka, Canton, MI (US); Ravikanth Raju Mudduluru, Southfield, MI (US)

(73) Assignee: Ford Global Technologies, LLC, Dearborn, MI (US)

(21) Appl. No.: 16/950,098

(22) Filed: Nov. 17, 2020

(51) Int. Cl. B60W 30/08; G06F 16/29; B60W 40/08; B60W 50/14; G01S 19/42; H04L 29/08

(52) U.S. Cl. CPC B60W 30/08; G06F 16/29; B60W 40/08; B60W 2540/043; G01S 19/42; H04L 67/12; B60W 2030/082; B60W 50/14

(57) ABSTRACT

Vehicle to device proximity detection using location comparison is disclosed herein. An example method includes establishing a geofence, the geofence extending around a perimeter of a vehicle or a fixed location, monitoring a vehicle location and a user device location, detecting occurrence of a triggering event, comparing the vehicle location, the user device location relative to one another and to the geofence, and executing a response, the response being conditioned upon the triggering event being exclusive or inclusive.

### BACKGROUND

It may be desirable to determine if a specific mobile device (such as phone, tablet, smartwatch, etc.) is located within a vehicle or not. For example, collision detection systems can be used to identify when a vehicle has been involved in a collision. As a post-collision experience, a mobile application can display relevant information and/or guides to help the driver work through post-collision documentation (such as taking pictures of the vehicles and/or accident scene, gathering driver information from all parties, gathering witness statements, getting roadside assistance, and so forth). This feature may only be pertinent to authorized users that are currently in the vehicle (i.e., authorized users that are not in the vehicle at the time of the incident may not need the same notification).

Some mobile applications include a geofence feature that can monitor vehicle location and can alert authorized users when the vehicle has entered or exited user-defined geofence boundaries, which can result in users receiving the same notification, even when the notification may not be pertinent to the user. Under certain circumstances, this could result in excessive messaging to the driver of the vehicle. For example, if a geofence is defined around a user's home, the driver of the vehicle knows that they have arrived “home” so they may not need the notification. If an authorized user leaves their phone in a vehicle, there is no current way to identify the phone's location.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 depicts an example scenario where techniques and structures for providing the systems and methods disclosed herein may be implemented.

FIG. 3 is a flowchart of an example method of the present disclosure.

FIG. 4 is a flowchart of another example method of the present disclosure.

### DETAILED DESCRIPTION

### Overview

The present disclosure is generally directed to systems and methods for vehicle-to-device and geofence proximity detection using location comparison. These systems and methods for mobile device to vehicle proximity/location determinations can be used in various contexts such as providing information to authorized users following a collision, when a user leaves their phone in a vehicle, and so forth. A geofence can be assigned to a vehicle and a mobile device's location can be compared to the vehicle geofence. Based upon this comparison, certain actions may be taken in certain situations based on whether the mobile device is determined to be in the geofence or not. For example, in a vehicle collision scenario, information may only be provided to an authorized user of a mobile device if they are determined to be inside the geofence so as to avoid excessive messaging to mobile devices outside the geofence.

A service provider (e.g., a cloud environment) can be configured to locate a location of a mobile device and compare the same to an assigned vehicle geofence. The geofence parameters can be established at the service provider level. Upon a triggering event (such as a car accident, geofence event, phone loss, power to the box (PTTB) activation—just to name a few), the mobile device's location can be defined as being (1) within the geofence assigned to the vehicle; or (2) outside the geofence assigned to the vehicle.

Upon retrieving the mobile device's location and the vehicle's location, the service provider can determine if the mobile device is in or outside the geofence. This determination can result in one or more mobile devices being located inside the geofence and/or one or more mobile devices being located outside the geofence. The service provider can determine, for each event identified, a particular response. These responses can be inclusive or exclusive based on the event type. For example, car accident events, device loss events, and PTTB events may be inclusive events, while geofence events can be exclusive.

### Illustrative Embodiments

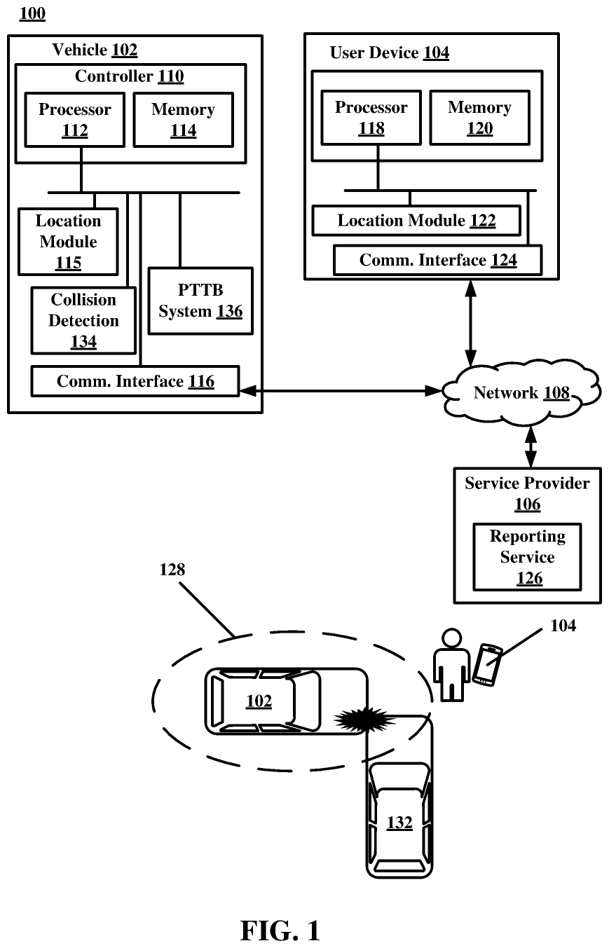

Turning now to the drawings, FIG. 1 depicts an illustrative architecture 100 in which techniques and structures of the present disclosure may be implemented. The architecture 100 can include a vehicle 102, a user device 104, a service provider 106, and a network 108. Each of these components in the architecture 100 can communicate using the network 108. The network 108 can include combinations of networks that enable the components in the architecture 100 to communicate with one another. The network 108 may include any one or a combination of multiple different types of networks, such as cable networks, the Internet, wireless networks, and other private and/or public networks. In some instances, the network 108 may include cellular, Wi-Fi, or Wi-Fi direct.

Generally, the vehicle 102 can comprise a controller 110 having a processor 112 and memory 114. The processor 112 executes instructions included in the memory 114 to perform functions or operations in accordance with the present disclosure, such as vehicle location reporting. In one configuration, the controller 110 can comprise a location module 115 that utilizes global positioning system (GPS) signals. These GPS signals can be processed by the controller 110 to determine and report a location of the vehicle 102 using a vehicle system such as a human machine interface (HMI) that provides navigation features. The GPS signals can also be transmitted to the service provider 106 when the vehicle includes a communications interface 116. Any suitable, techniques, systems, and methods may be used to determine the location of the vehicle. For example, other satellite systems may be used, as well as cellular triangulation, wi-fi network mapping, etc. to determine the location of the vehicle.

The user device 104 can include any mobile device such as a smartphone, a smartwatch, a laptop, or other similar mobile user equipment. The user device 104 can comprise a processor 118 and memory 120. The processor 118 executes instructions included in the memory 120 to perform functions or operations in accordance with the present disclosure, such as user device location reporting. Example instructions can include an application that allows a user of the user device 104 to interact with the services or functionalities enabled through use of the service provider 106.

In one configuration, user device 104 can include a location module 122 that utilizes global positioning system (GPS) signals. These GPS signals can be evaluated by the processor 118 to determine and report a location of the user device 104. The GPS signals can also be transmitted to the service provider 106 and/or the vehicle 102 when the user device 104 includes a communications interface 124. The communications interface 124 can also allow the user device 104 to communicatively couple, directly or indirectly, with the vehicle 102. For example, the user device 104 and vehicle 102 can communicatively couple over a wired connection or a wireless connection such as Bluetooth™.

The service provider 106 can comprise a cloud resource that enables a location-based event reporting service (“reporting service 126”). In general, vehicles and user devices can register with the reporting service 126 and agree to report their location to the reporting service 126.

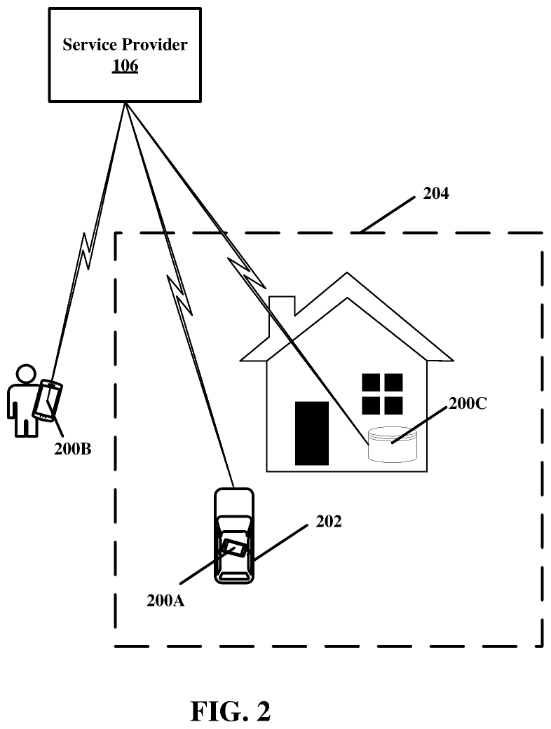

The reporting service 126 can receive location signals from both the vehicle 102 and the user device 104 and make determinations in accordance with the location-based responses disclosed herein. The service provider 106 can establish a geofence 128 around the vehicle 102. This geofence 128 can include a bounded region around the vehicle 102 that is dynamic and moves with the vehicle 102. The geofence 128 could alternatively pertain to a fixed location, such as a location around a house. Alternative, example scenarios are described and illustrated in FIGS. 2-4. To be sure, any particular scenario can involve additional vehicles and/or user devices. These vehicles or user devices can be located inside or outside an established geofence. The geofence may be any suitable size, shape, or configuration. In some instances, the geofence may be adjustable. The size and shape of the geofence may be dependent of the particular situation and scenario. The service provider 106 can establish the size and shape (e.g., circular, square, polygon, triangular, etc.) geofence based any number of parameters or situational factors.

The reporting service 126 can be configured to receive the location information from vehicles and user devices, as well as establish geofences. The reporting service 126 can also compare the location of a user device to a vehicle and determine if the vehicle and/or user device are present in an established geofence. The reporting service 126 can also execute one or more responses based on a triggering event. Example triggering events include, but are not limited to, a collision involving the vehicle 102, entering/exiting of a geofence by a user device or a vehicle, a user misplacing or losing their user device, and/or activation of a PTTB features (when the vehicle 102 is enabled with a PTTB system). These event-driven determinations can elicit responses from the reporting service 126, based on inclusivity or exclusivity. The nature of exclusivity and/or inclusivity will be elucidated with examples provided infra.

In a first example use case, the geofence 128 is created by the reporting service 126 around the vehicle 102. For example, the geofence 128 can be defined in a perimeter around the vehicle 102. The perimeter can have any desired shape and can extend at any distance D away from the vehicle. A driver or passenger in the vehicle 102 is associated with the user device 104. The vehicle 102 has been in an accident with an additional vehicle 130. In this particular scenario, the controller 110 of the vehicle 102 can receive an indication from a collision detection system 132 of the vehicle 102 that the collision has occurred. To be sure, a collision need not occur with another vehicle, but may include the vehicle 102 being involved in any event that is determined by the collision detection system 132 to be a collision. It will be understood that the collision is a triggering event that may elicit a response from the service provider 106.

As a post-collision experience, the user device 104 (through use of a mobile application or otherwise) can display relevant information and/or guides to instruct the driver. For example, instructions or messages can be provided that allow the driver to process through post-collision steps such as taking pictures of the vehicles and/or collision scene, gathering driver information from all parties, witness statements, and order roadside assistance (such as towing or ride-hailing)—just to name a few. The user device 104 can transmit details of the collision to the service provider 106 and the service provider 106 can invoke one or more responses. Example responses include, but are not limited to, transmitting messages to relevant parties involved the collision, transmitting details of the collision to an insurance company, and/or dispatching a towing service. The service provider 106 determines which user devices are co-located with the first vehicle 102 based on received location information. This can include identifying user devices present within the geofence 128 established for the vehicle 102. In some instances, user devices outside the geofence 128 may not be included in any response while user devices inside the geofence 128 may be included. This location-limited response reduces messages to users/user devices not involved in the accident and reduces the panic of users by giving them control over the post-collision process, while not alerting parties that are not pertinent to the collision. In other instances, user devices outside the geofence 128 may be included in the response. For example, the service provider could be configured to exclude devices that are not within the geofence or it could have an option to provide a different user experience, wherein user A is within the geofence and is delivered the post-collision experience described, and user B is outside the geofence and is delivered a different post-collision experience (i.e. information about where the accident occurred, severity reported by the collision detection system etc.).

This collision-related functionality may only be relevant to authorized users that are currently in the vehicle (authorized users that are not in the vehicle at the time of the incident may not need the same or any notification). Thus, this is an example of an inclusive situation where messages or responses are relevant to users/user devices that are co-located with the vehicle.

FIG. 2 illustrates another example use case related to a geofence-based response scenario. The service provider 106 receives location information from registered vehicles and user devices. For example, the service provider 106 monitors the locations of user devices 200A-200C, as well as a vehicle 202. A geofence 204 can be established around a home 206. While a home has been illustrated, the geofence can be established with respect to any fixed location. In general, the user device 200A is associated with a driver of the vehicle 220, while user device 200B is associated with a who is not present in the vehicle 202, and the user device 200C is a digital home assistance, connected device.

In this scenario, the service provider 106 can monitor location of vehicle 202 and can alert authorized users when the vehicle 202 has entered or exited user defined geofence 204 boundaries. Again, the service provider 106 determines relevant user devices to notify using location signals received therefrom. The service provider 106 also monitors the location of the vehicle 202 relative to the geofence 204. The service provider 106 can evaluate the location of both user device and vehicles relative to the geofence of the fixed location.

Without having device-to-vehicle proximity identification each of the user devices 200A-200C may receive the same notification. This type of notification may be irrelevant or unwanted by the driver of the vehicle 202, as the driver implicitly knows the location of the vehicle. Therefore, under certain circumstances, this could result in excessive messaging to the driver of the vehicle. Thus, if a geofence is defined around a user's home or place of work, the driver of the vehicle knows that they have arrived so they do not need the notification. The message may likely be pertinent to users of devices 200B and/or 200C who may be family members or co-workers. This scenario is an example exclusive event where user devices that are outside of the geofence 204 are notified, while user devices outside the geofence 204 are not notified. It will be understood that the entrance or exit of the vehicle relative to the geofence is a triggering event that may elicit a response from the service provider 106. This can be extended to a user device entering or exiting the geofence rather than, or in addition to, the vehicle.

In another example use case, an authorized user may leave their phone in a vehicle. Without the use of vehicle-to-device location comparisons there would be no way to identify the user device's location. The user can report their user device loss to the service provider. A user device-to-vehicle proximity identification can be triggered by the service provider. The service provider can identify that the user device is within a geofence established around a perimeter of the vehicle. The service provider can notify a user of the lost user device by a selected communication method using a connected device (such as a digital home assistant (see 200C of FIG. 2 as an example, email, and so forth) that the user device was left in the vehicle. Thus, this is another example of where an inclusive scenario/event where the user device and vehicle are co-located and both are within a geofence. It will be understood that the loss of the user device is a triggering event that may elicit a response from the service provider 106.

In yet another scenario, the service provider can monitor the location of a user device associated with a user, as well as a location of a vehicle. This example is another inclusive event. Again, a geofence can be established around a vehicle as set forth above. In this example, the vehicle can include a PTTB system (see PTTB system 136 of FIG. 1). In this example, the user can activate a generator of the vehicle using the PTTB system 136 in order to power machinery.

For example, the user can power a tool such as a radial saw using the PTTB system 136. In order to ensure safe operation, a user needs to be near the vehicle to ensure that the tool is operated in a safe area. Thus, the service provider can monitor the location data of the user device that activated the PTTB system 136 relative to the geofence. When the user device travels outside the grofence, the service provider can transmit a signal to disable the PTTB system 136. To be sure, while a service provider has been disclosed in this example, the process disclosed above can also be mediated only between the user device and the vehicle. It will be understood that the entrance or exit of the user device relative to the geofence, when the PTTB system 136 is active, is an example triggering event that may elicit a response from the service provider 106.

The service provider may allow or deny the user's ability of sending commands to any system or subsystem of the vehicle based on the in/out result of the device to the geofence check. For example, the user's proximity may be confirmed before the user can control power closures (back end closure, windows, moonroof, convertible top, etc.). Opening these power closures while very far from the vehicle may be prevented as it may not be possible to re-close the movable closure due to obstruction or fault. This would leave the vehicle in a compromised state. If the user is confirmed to be within a certain distance, then they would be able to physically go to the vehicle to fix the situation.

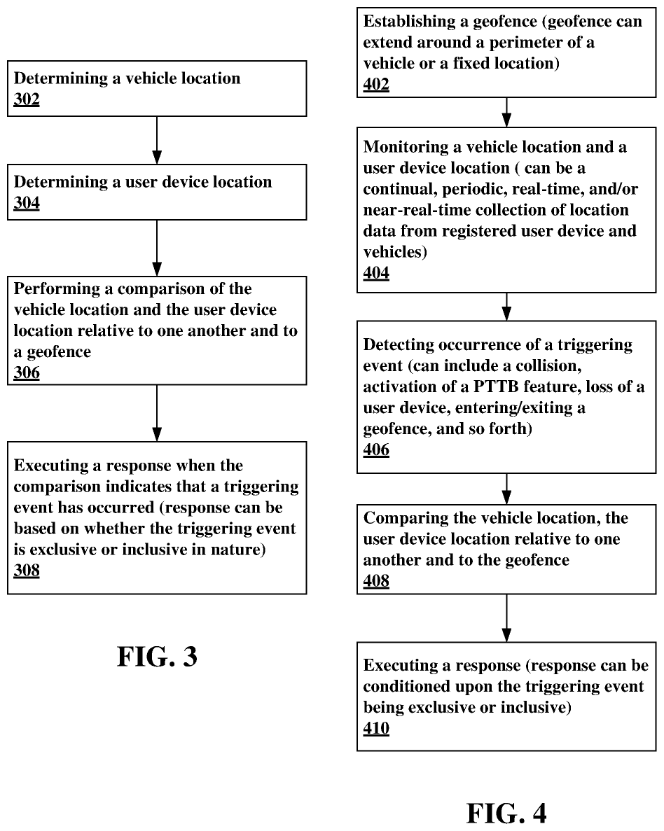

FIG. 3 is a flowchart of an example method. The method can be executed by a service provider of the present disclosure. The method can include a step 302 of determining a vehicle location. The location information can be transmitted to a service provider over a network. Next, the method can include a step 304 of determining a user device location. Again, this location information can be transmitted to a service provider over a network.

The method can include a step 306 of performing a comparison of the vehicle location and the user device location relative to one another and to a geofence. As noted above, the geofence can be established as a dynamic perimeter around the vehicle, or a fixed boundary around a location.

Next, the method can include a step 308 of executing a response when the comparison indicates that a triggering event has occurred. The response can be based on whether the triggering event is exclusive or inclusive in nature.

FIG. 4 is a flowchart of another example method. The method can be executed by a service provider of the present disclosure. The method can include a step 402 of establishing a geofence. To be sure, the geofence can extend around a perimeter of a vehicle or a fixed location. In some instances, the boundaries of the geofence are established by a user. The method can also include a step 404 of monitoring a vehicle location and a user device location. This can be a continual, periodic, real-time, and/or near-real-time collection of location data from registered user device and vehicles.

The method can include a step 406 of detecting occurrence of a triggering event. The triggering event can include a collision, activation of a PTTB feature, loss of a user device, entering/exiting a geofence, and so forth. The method includes a step 408 of comparing the vehicle location, the user device location relative to one another and to the geofence. Based on the triggering event and/or the comparison, the method can include a step 410 of executing a response. As noted above, the response can be conditioned upon the triggering event being exclusive or inclusive.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” and the like indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method, comprising:
determining a location of a vehicle;
determining a location of a user device;
performing a comparison of the vehicle location and the user device location relative to one another and to a geofence; and
executing a response when the comparison indicates that a triggering event has occurred.

2. The method according to claim 1, wherein the geofence is dynamic and extends around a perimeter of the vehicle.

3. The method according to claim 1, wherein the geofence surrounds a fixed location.

4. The method according to claim 1, wherein the response comprises transmitting a message to the user device or another user device based on the triggering event being inclusive or exclusive.

5. The method according to claim 1, wherein the triggering event comprises the user device leaving the geofence when a power-to-the-box feature of the vehicle is enabled.

6. The method according to claim 5, further comprising transmitting a signal to the vehicle to disable the power-to-the-box feature when the user device leaves the geofence.

7. The method according to claim 1, wherein the triggering event comprises a collision of the vehicle as determined by a collision detection system of the vehicle.

8. The method according to claim 7, further comprising executing a post-collision experience on the user device based on the collision.

9. The method according to claim 1, wherein the triggering event comprises a user of the user device identifying that the user device is lost, the method further comprising determining that the user device location is co-located with the vehicle location and the geofence.

10. The method according to claim 9, further comprising transmitting a message to a connected device that informs the user that the user device is inside the vehicle.

11. A method, comprising:
establishing a geofence, the geofence extending around a perimeter of a vehicle or a fixed location;
monitoring a vehicle location and a user device location;
detecting occurrence of a triggering event;
comparing the vehicle location, the user device location relative to one another and to the geofence; and
executing a response, the response being conditioned upon the triggering event being exclusive or inclusive.

12. The method according to claim 11, wherein the response comprises transmitting a message to the user device or another user device based on the triggering event being inclusive or exclusive.

13. The method according to claim 11, wherein the triggering event comprises the user device leaving the geofence when a power-to-the-box feature of the vehicle is enabled.

14. The method according to claim 13, further comprising transmitting a signal to the vehicle to disable the power-to-the-box feature when the user device leaves the geofence.

15. The method according to claim 11, wherein the triggering event comprises a collision of the vehicle as determined by a collision detection system of the vehicle, the method further comprising executing a post-collision experience on the user device based on the collision.

16. The method according to claim 11, wherein the triggering event comprises a user of the user device identifying that the user device is lost, the method further comprising determining that the user device location is co-located with the vehicle location and the geofence, the method further comprising transmitting a message to a connected device that informs the user that the user device is inside the vehicle.

17. A system, comprising:
a processor and memory for storing instructions, the processor executes the instructions to:
determine a location of a vehicle;
determine a location of a user device;
perform a comparison of the vehicle location and the user device location relative to one another and to a geofence; and
execute a response when the comparison indicates that a triggering event has occurred.

18. The system according to claim 17, wherein the triggering event comprises the user device leaving the geofence when a power-to-the-box feature of the vehicle is enabled, and the processor is configured to further transmit a signal to the vehicle to disable the power-to-the-box feature when the user device leaves the geofence.

19. The system according to claim 17, wherein the triggering event comprises a collision of the vehicle as determined by a collision detection system of the vehicle, and the processor is configured to execute a post-collision experience on the user device based on the collision.

20. The system according to claim 17, wherein the triggering event comprises a user of the user device identifying that the user device is lost, the processor is configured to determine that the user device location is co-located with the vehicle location and the geofence, and the processor is configured to transmit a message to a connected device that informs the user that the user device is inside the vehicle.
